(19) United States
(12) Patent Application Publication
(10) Pub. No.: US 2005/0105554 A1
(43) Pub. Date: May 19, 2005

(54) Method and switch system for optimizing the use of a given bandwidth in different network connections

(76) Inventors: Michael Kagan, Zichron Yaakov (IL); Alon Webman, Tel-Aviv (IL); Ido Bukspan, Tel-Aviv (IL); Ran Ravid, Tel-Aviv (IL); Itai Zahavi, Raanana (IL); Danny Koplev, Tel-Aviv (IL); Tall Roll, Tel-Aviv (IL); Hillel Chapman, Ein Aemek (IL)

Correspondence Address: DR. MARK FRIEDMAN LTD.;c/o Bill Polkinghorn, Discovery Dispatch, 9003 Florin Way, Upper Marlboro, MD, 20772, US

(21) Appl. No.: 10/990,484

(22) Filed: Nov. 18, 2004

Related U.S. Application Data
(60) Provisional application No. 60/520,666, filed on Nov. 18, 2003.

(51) Int. Cl. H04J 3/18

(52) U.S. Cl. 370/468

(57) ABSTRACT

A method and switch system for optimizing the use of a given bandwidth in different communication network connections. The method comprises providing port bandwidth resources at a port of the network, and dynamically and automatically allocating said port bandwidth resources. In a preferred embodiment, the bandwidth resources include a cluster of 3 ports with a given bandwidth of 12x, which can be declared as a 12x port and two 4x ports or as a trio of three 4x ports. The declaration causes dynamic and automatic configuration of the three ports, thereby optimizing the use of the given bandwidth.

### CROSS REFERENCE TO RELATED APPLICATIONS

The present invention claims priority from U.S. Provisional Patent Application No. 60/520,666, filed 18 Nov. 2003, the contents of which are incorporated herein by reference.

### FIELD AND BACKGROUND OF THE INVENTION

The present invention relates to communications networks, and in particular to the dynamic allocation of bandwidth (BW) at ports of such networks.

InfiniBand (IB) is the present state-of-the art protocol for network communications. The IB protocol defines the procedure to raise a link by a network port from a user to a peer. One of parameter a port negotiates before raising up a link is maximum bandwidth. In the existing art, the raising of a link proceeds by first trying to raise the maximum BW supported by the port (e.g. 12x). If this bandwidth cannot be raised, the next step is a trial to raise the next lower BW link (e.g. 4x). If this is unsuccessful, the next trial is to raise an even lower BW link (1x) as defined in the InfiniBand (IB) specification. If the maximum successfully raised BW is 4x (i.e. if the host channel adapter supports only a 4x link) one basically loses ⅔ of the maximum bandwidth supported by the switch port (12x).

There is thus a widely recognized need for, and it would be highly advantageous to have, a method and system by which bandwidth losses are avoided at a port that tries to raise a link of maximum bandwidth.

### SUMMARY OF THE INVENTION

The present invention discloses a method and a switch system (referred to simply as a “switch”) for dynamically controlling bandwidth maximalization at a network port. The invention provides a capability to support a bandwidth split at a port cluster (also referred to as “port”) of the switch (e.g. a 12x port can also function in a configuration of a “trio” of three 4x (“3-4x”) ports). A particularly advantageous inventive feature is the ability to auto-negotiate between two options, 12x and 3-4x, during hot insertion. Hot insertion in the case of this auto-negotiation may pose a problem to the subnet manager: if the switch declares a port to be 12x (when it is still down) and the port is then configured as 3-4x, the subnet manager suddenly discovers two new ports that were previously undeclared (e.g. the port number may change and the routing table needs to be updated). We solve this problem as explained below.

In the inventive approach disclosed herein, the switch can change the port configuration (maximum bandwidth or split bandwidth) dynamically, while prior art switches do this statically. The port first tries to raise a 12x link. If it fails, it changes the configuration to 3-4x and tries to raise each 4x link separately. A second advantageous feature is to enable hot insertion in a system: in order to avoid the appearance or disappearance of a port in a hot insertion, our switch always declares (in response to a query from the subnet manager) the maximum number of ports (3 for a cluster, and N for a switch where N is an integer>1). Each cluster of 3 ports can raise a link as 12x or 3-4x. In each such cluster, there is one master and two slaves. The switch always declares the master with a maximum BW as 12x, while each slave is declared with a maximum BW of only 4x. If the master port raises a 12x (maximum BW) link successfully and uses the entire physical lane (11-0), the configuration is set to be “single” and the two slaves will stay in a “disable” state (i.e. they basically do not have a physical connection outside the switch). The “disable” state is defined in the IB specification. If the master port fails in raising the maximum bandwidth, then the two slaves are woken up from the disable state, and each of the 3 ports tries to raise a link separately (while the maximum BW of each port is 4x). If one of 4x links succeeds, then the configuration is set to “trio”. Otherwise, the master tries to raise a link again in the 12x configuration, and two slaves go back into the disable state. This procedure continues until one of the links comes up and the configuration is set.

According to the present invention there is provided, in a communications network, a method for optimizing the use of a given bandwidth in different network connections, comprising the steps of providing port bandwidth resources at a port of the network; and dynamically and automatically allocating the port bandwidth resources, whereby the dynamic allocation optimizes and maximizes the use of the given bandwidth.

According to one feature in the method for optimizing the use of a given bandwidth in different network connections, the step of providing bandwidth resources includes providing a three port cluster with a bandwidth of 12x declared as a port of 12x and two ports of 4x each, whereby the declaration makes the dynamic and automatic allocation transparent to a subnet manager.

According to another feature in the method for optimizing the use of a given bandwidth in different network connections, the step of providing bandwidth resources includes providing a three port cluster with a bandwidth of 12x declared as a trio of 4x ports, whereby the declaration makes the dynamic and automatic allocation transparent to a subnet manager.

According to yet another feature in the method for optimizing the use of a given bandwidth in different network connections, the step of dynamically and automatically allocating includes connecting to one peer at a maximum bandwidth smaller than the given bandwidth, the difference between the maximum bandwidth and the given bandwidth being a remainder bandwidth, and using the remainder bandwidth to connect to at least one other peer.

According to yet another feature in the method for optimizing the use of a given bandwidth in different network connections, the using of the remainder bandwidth to connect to at least one other peer includes using the remainder bandwidth to connect to at least one peer selected from the group consisting of a 4x port and a 1x port.

According to the present invention there is provided a method for optimizing bandwidth utilization at a network port, comprising the steps of providing a cluster of three ports configured to carry a given bandwidth, and dynamically and automatically allocating bandwidth among the three ports in order to optimize the use of the given bandwidth.

According to the present invention there is provided a switch system for optimizing the use of a given bandwidth in different network connections, comprising a switch with a plurality of port clusters, each cluster comprising three ports; and a dynamic bandwidth allocation mechanism operative to configure automatically each cluster in a manner in which the use of the given bandwidth is optimized.

### BRIEF DESCRIPTION OF THE DRAWINGS

The invention is herein described, by way of example only, with reference to the accompanying drawings, wherein:

FIG. 1 shows a flow chart of a preferred embodiment of the method of the present invention;

FIG. 2 shows a high level schematic physical description of the switch of the present invention;

FIG. 3 shows an InfiniScale III fabric logical view;

FIG. 4 shows the steps of the method of the present invention in more detail.

### DESCRIPTION OF THE PREFERRED EMBODIMENTS

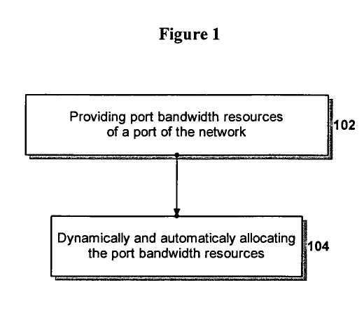

The present invention provides a method and switch system for optimizing the use of a given bandwidth at a port of a switch in a communications network, for use in different network connections. The present invention provides a switch that facilitates this optimization by dynamic configuration of the given bandwidth in a manner which is transparent to a subnet manager, and which does not disturb traffic on other ports of the network. As shown schematically in FIG. 1, the method comprises providing port bandwidth resources at a port of the network in step 102, and dynamically and automatically allocating the port bandwidth resources in step 104, whereby the dynamic allocation optimizes and maximizes the use of the given bandwidth. The bandwidth resources provided in step 102 include, for each network port, a cluster of three ports in which the bandwidth may be declared as 12x for one port, and 4x for each of the two other ports, or a cluster in which the three ports are declared as 4x each. The declaration and configuration of the cluster is done dynamically and transparently to the system manager. Advantageously, the dynamic configuration and allocation at one port does not interfere with traffic at other ports.

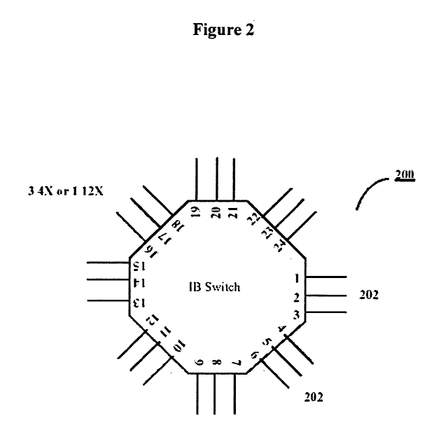

In one exemplary embodiment, the three-port cluster (see schematic physical view in FIG. 2) has a given bandwidth of 12x, wherein the three ports are declared as 12x/4x/1x (port 0) plus 4x/1x (port 1) plus 4x/1x (port 2). We now describe the switch system that facilitates the implementation of the method, then describe the method in more detail.

FIG. 2 shows a high level schematic description of a switch 200, referred to herein also as “Infiniscale III”. Switch 200 supports InfiniBand (IB) links, i.e. 24 IB 4x (10 Gbit/Sec.) ports 1-24, arranged exemplarily in eight IB port clusters 202 (only two of which are marked). Each port cluster can be independently configured at run-time to a single 12x port or to three 4x ports (indicated as “3 4x or 1 12x” on one such cluster).

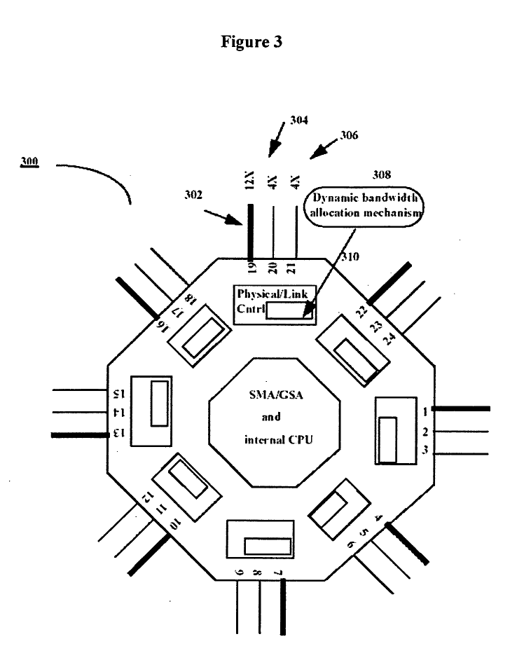

FIG. 3 shows a preferred embodiment of a switch system 300 according to the present invention (also referred to as an InfiniScale III fabric logical view). System 300 comprises a switch 310 with subnet manager agent/(SMA/GSA) and internal CPU functionalities and, exemplarily, 8 clusters of three ports, similar to FIG. 2. Each port cluster is coupled to a dynamic bandwidth allocation mechanism 308, which is operative to configure automatically each cluster in a manner in which the use of the given bandwidth is optimized. Mechanism 308 is preferably included in switch 310, and is part of a physical/link layer control, which is a known functions in InfiniBand. InfiniScale III declares itself to the system manager (SM) as a 24-port switch; eight of the 24 ports have 12x capability. In the exemplary 8-cluster switch as in FIG. 2, each cluster can be independently configured to a single 12x port or to three 4x ports (trio mode), i.e. one port is 12x/4x/1x and the other two ports are 4x/1x. This configuration can be determined at link training time. If a given port cluster is trained as a 12x port (e.g. 302), the adjacent 4x logical ports (304 and 306) will be reported as unconnected (i.e., in the physical link down state). Alternatively, the port cluster can be auto-configured to operate as three 4x ports (based on link training), in which case all three logical ports (302-306) will be operational. This functionality enables re-configuring a 12x port to three 4x ports transparently to the SM and without disturbing traffic on other ports. In addition, each logical 4x port can be trained as a 1x port at link bring-up.

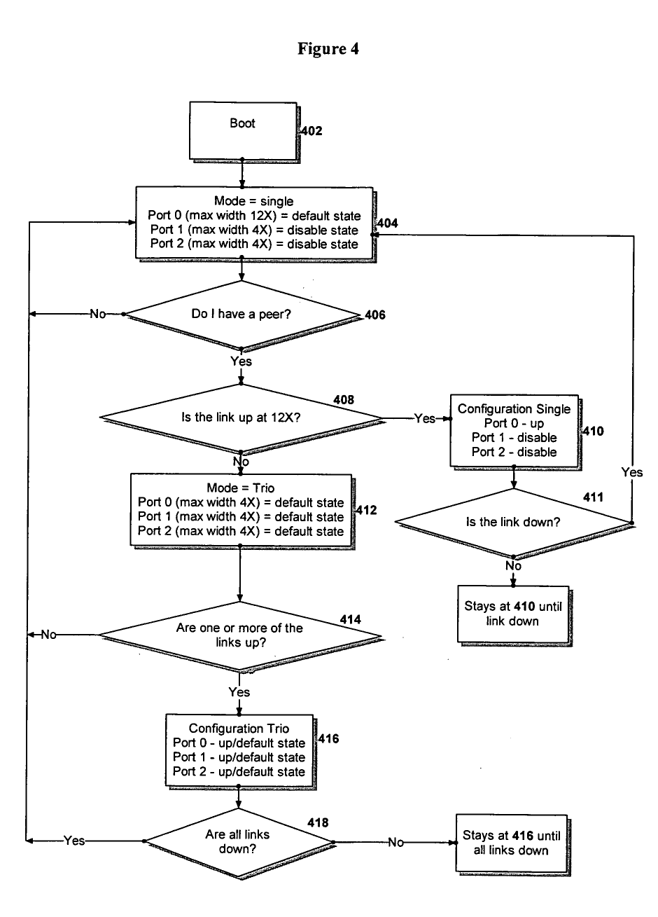

Returning now to the method, FIG. 4 shows a flow chart with more details of the steps. After a “Boot” step 402, a cluster with three ports 0, 1 and 2 is configured as single mode in step 404: port 0 is set to 12x and configured to “default” state (which is the initial state in which he may raise a link. also defined in the IB specification), while ports 1 and 2 are each set as a 4x (or 4/1x) port and configured to a disable state. All along this procedure, the declaration to the subnet manager is the same 12x plus 4x plus 4x. The difference is the configuration in the cluster, i.e. what the subnet manager sees when he/she queries the different states of these ports. This is followed by a search step 406 to detect a peer. If a peer is detected (“yes”), the cluster tries to link up at 12x in step 408. If it succeeds (“yes”) , port 0 is “up” and ports 1 and 2 are in the “disable” state in step 410. A check is then done in step 411 to see if the link is down. If “yes”, the routine returns to step 404. If “no”, the configuration stays as in 410 until the link is down. If the attempt to raise a link at 12x in step 408 fails (“no”) the cluster goes automatically into a “trio” mode in step 412. In this case, each of the three ports is set as a 4x port, and configured to the default state. The cluster logic (not shown) then checks if one or more of the 4x ports was successful in bringing up the link in step 414. If yes, the cluster is configured as “trio” in step 416, with all three ports in “up” or default state. The cluster logic then checks if all links are “down” in step 418. If “yes” (all three 4x port links are changed to “down”, e.g. if someone disconnected the communications cable) then the process returns to step 404. Otherwise (“no”), the switch stays in the trio mode.

While the invention has been described with respect to a limited number of embodiments, it will be appreciated that many variations, modifications and other applications of the invention may be made.

1. In a communications network, a method for optimizing the use of a given bandwidth in different network connections, comprising the steps of:
a. providing port bandwidth resources at a port of the network; and
b. dynamically and automatically allocating said port bandwidth resources, whereby said dynamic allocation optimizes and maximizes the use of said given bandwidth.

2. The method of claim 1, wherein said step of providing bandwidth resources includes providing a three-port cluster with a bandwidth of 12x declared as a port of 12x and two ports of 4x each, whereby said declaration makes said dynamic and automatic allocation transparent to a subnet manager.

3. The method of claim 1, wherein said step of providing bandwidth resources includes providing a three-port cluster with a bandwidth of 12x declared as a trio of 4x ports, whereby said declaration makes said dynamic and automatic allocation transparent to a subnet manager.

4. The method of claim 1, wherein said step of dynamically and automatically allocating includes:
i. connecting to one peer at a maximum bandwidth smaller than the given bandwidth, the difference between said maximum bandwidth and said given bandwidth being a remainder bandwidth, and
ii. using said remainder bandwidth to connect to at least one other peer.

5. The method of claim 4, wherein said using said remainder bandwidth to connect to at least one other peer includes using said remainder bandwidth to connect to at least one peer selected from the group consisting of a 4x port and a 1x port.

6. The method of claim 2, facilitated by a switch system having 8 said clusters.

7. The method of claim 3, facilitated by a switch system having 8 said clusters.

8. A method for optimizing bandwidth utilization at a network port, comprising the steps of:
a. providing a cluster of three ports configured to carry a given bandwidth; and
b. dynamically and automatically allocating bandwidth among said three ports in order to optimize the use of said given bandwidth.

9. The method of claim 8, wherein said step of providing a cluster of three ports includes providing a cluster with a bandwidth of 12x declared as a port of 12x and two ports of 4x each, whereby said declaration makes said dynamic and automatic allocation transparent to a subnet manager.

10. The method of claim 8, wherein said step of providing a cluster of three ports includes providing a cluster with a bandwidth of 12x declared as a trio of 4x ports, whereby said declaration makes said dynamic and automatic allocation transparent to a subnet manager.

11. The method of claim 8, wherein said step of dynamically allocating includes:
i. connecting to one peer at a maximum bandwidth smaller than the given bandwidth, the difference between said maximum bandwidth and said given bandwidth being a remainder bandwidth, and
ii. using said remainder bandwidth to connect to at least one other peer.

12. The method of claim 11, wherein said using said remainder bandwidth to connect to at least one other peer includes using said remainder bandwidth to connect to at least one peer selected from the group consisting of a 4x port and a 1x port.

13. The method of claim 9, facilitated by a switch system having 8 said clusters.

14. The method of claim 10, facilitated by a switch system having 8 said clusters.

15. A switch system for optimizing the use of a given bandwidth in different network connections, comprising
a. a switch with a plurality of port clusters, each cluster comprising three ports; and
b. a dynamic bandwidth allocation mechanism operative to configure automatically each cluster in a manner in which the use of the given bandwidth is optimized.

16. The system of claim 15, wherein each said cluster has a 12x bandwidth, and wherein said allocation mechanism is operative to declare said cluster as a 12x port and two 4x ports.

17. The system of claim 15, wherein each said cluster has a 12x bandwidth, and wherein said allocation mechanism is operative to declare said cluster as a trio of 4x ports.

18. The system of claim 16, wherein said plurality of port clusters includes 8 clusters.

19. The system of claim 17, wherein said plurality of port clusters includes 8 clusters.
